(19) United States
(12) Patent Application Publication
(10) Pub. No.: US 2022/0382833 A1
(43) Pub. Date: Dec. 1, 2022

(54) METHODS AND APPARATUS FOR AUTOMATIC ANOMALY DETECTION

(71) Applicant: AirHop Communications, Inc., San Diego, CA (US)

(72) Inventors: Christopher Riddle, San Diego, CA (US); Gary Jorgensen, San Diego, CA (US); Bijan Golkar, San Diego, CA (US); David Chang, San Diego, CA (US)

(73) Assignee: AirHop Communications, Inc., San Diego, CA (US)

(21) Appl. No.: 17/483,288

(22) Filed: Sep. 23, 2021

Related U.S. Application Data
(60) Provisional application No. 63/188,384, filed on May 13, 2021.

(51) Int. Cl. G06F 17/18; G06F 17/16; G06F 11/34

(52) U.S. Cl. CPC G06F 17/18; G06F 17/16; G06F 11/3495

(57) ABSTRACT

Techniques for automatic adaptive anomaly detection are disclosed. In some embodiments, a system, a process, and/or a computer program product for automatic anomaly detection includes handling invalid or missing data, building a model for the normal or typical statistical relationship between data, using the model to generate an anomaly score for each input set of data, threshold detection and persistence filtering, and automatic label generation for detected anomalies.

### PRIORITY

This application claims the benefit of priority to U.S. Provisional Patent Application Ser. No. 63/188,384 filed May 13, 2021 and entitled “METHODS AND APPARATUS FOR AUTOMATIC ANOMALY DETECTION”, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### Technical Field

This disclosure relates generally to the field of detecting anomalous behavior in systems with numeric metrics. Specifically, the present disclosure is directed to hardware, software, and/or firmware implementations of anomaly detection.

### Description of Related Technology

Anomaly detection or outlier detection is applicable to a wide range of applications. Traditional anomaly detection algorithms are often custom built using expert domain knowledge. The advent of machine learning has enabled a wide range of approaches and software tools to perform anomaly detection.

Existing techniques for anomaly detection are designed to measure specific metrics that are made available to the algorithm. Metrics could include measurements of the speed of a vehicle, a number of connected devices to a router, the amount of data traffic in a network, and/or any number of other measurable quantities. The measurements could be numeric values such as miles per hour (mph), number of devices, or megabytes per second (MB/s). Across a range of applications there are countless metrics that could be generated.

Typical anomaly detection algorithms required a domain expert to select the key metrics (often referred to as the Key Performance Indicators (KPI)) and craft an anomaly detection algorithm to generate an alarm when anomalous values are detected. Anomalous values are values outside the range of normal operation, and the detection often results in some kind of alarm. Detected anomalies may or may not indicate a problem with the monitored system; anomalies just mean significant deviation from the normal operation. For example, while a surge in data traffic may be anomalous, it may not indicate a problem with a wireless network. However, a surge in lost data traffic could indicate a problem with the network.

Unfortunately, domain experts often limit their anomaly detection algorithms to only a few KPI to keep the complexity of the anomaly detection algorithm manageable. This leaves out other KPI which may be less important but which, if included, could further improve anomaly detection.

### SUMMARY

The present disclosure addresses the foregoing needs by disclosing, inter alia, methods, devices, systems, and computer programs for automatic adaptive anomaly detection.

In one aspect, systems, methods, and apparatus for automatic adaptive anomaly detection are disclosed.

Other features and advantages of the present disclosure will immediately be recognized by persons of ordinary skill in the art with reference to the attached drawings and detailed description of exemplary embodiments as given below.

### BRIEF DESCRIPTION OF THE DRAWINGS

FIG. 1 is a logical block diagram of a homogenous wireless network architecture useful to explain various aspects of the present disclosure.

FIG. 2 is a logical block diagram of a heterogenous wireless network architecture useful to explain various aspects of the present disclosure.

FIG. 3 is a logical flow diagram of an exemplary method for automatic adaptive anomaly detection in accordance with various aspects of the present disclosure.

FIG. 4 provides exemplary screenshots that may be useful in explaining various aspects of the present disclosure.

FIG. 5 is a logical flow diagram of a generalized method for anomaly detection in accordance with various aspects of the present disclosure.

FIG. 6 is a logical block diagram of an apparatus configured to detect anomalies in accordance with various aspects of the present disclosure.

### DETAILED DESCRIPTION

In the following detailed description, reference is made to the accompanying drawings which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

### Network Planning Challenges of 5G Networks

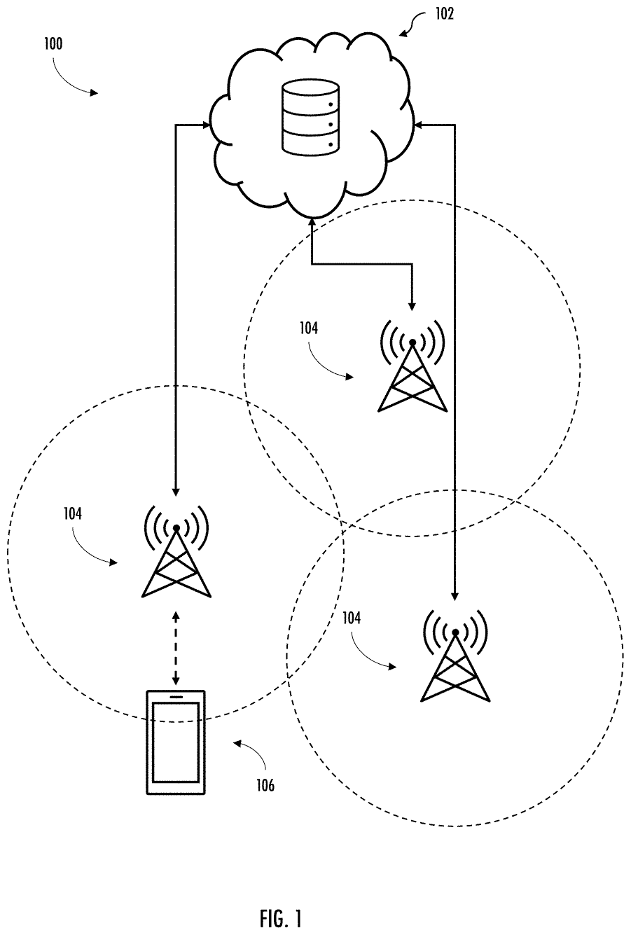

Cellular networks have been historically designed around homogenous networking assumptions. FIG. 1 is a logical block diagram of a homogenous wireless network architecture 100 useful to explain various aspects of the present disclosure. As shown therein, the cellular network includes a network operator's compute resources 102 that manage a Radio Access Network (RAN) composed of a number of base stations 104 running a homogenous communication protocol that provides coverage to user equipment 106. For example, a 3G base station could only communicate with 3G cellular devices using a single wireless networking protocol (e.g., UMTS, CDMA2000, etc.)

More recent 4G cellular networking technologies (e.g., LTE, LTE-A) have attempted to support heterogenous networking to varying degrees of success. For instance, the 3rd Generation Partnership Project (3GPP) promulgated a number of technical specifications directed to Wi-Fi and LTE interworking. Unfortunately, one of the most difficult problems for optimizing cellular network deployments is interference management. Homogenous networks (e.g., 3G and 4G) make basic assumptions based on geographic RAN deployment; thus, cellular coverage was largely determined by base station density, transmission power, and placement. For example, as shown in FIG. 1, the base stations 104 are deployed to minimize interference.

5G is the first wireless networking technology that is structurally designed to concurrently support multiple different wireless technologies. Incipient 5G networks will support a variety of different applications, each with different usage requirements. Notably, such applications span ultra-low power applications (e.g., Internet-of-Things (IoT)), high-throughput applications (Enhanced Mobile Broadband (eMBB)), low-latency applications (Ultra Reliable Low Latency Communications (URLLC)), and/or machine-only applications (Massive Machine Type Communications (mMTC)). Since many of the usage requirements may require design trade-offs, the 5G technical specifications have mandated that different technologies must work together. For example, so-called “Low-band 5G” is designed to provide 30-250 megabits per second (Mbit/s) over a coverage area and bandwidth (600-850 MHz) that is similar to 4G. So-called “Mid-band 5G” may provide 100-900 Mbit/s using very large frequency bands (2.5-3.7 GHz) to provide service over long distances; “High-band 5G” may offer extraordinarily fast data rates (multiple Gigabit/s (Gbit/s)) over very short distances.

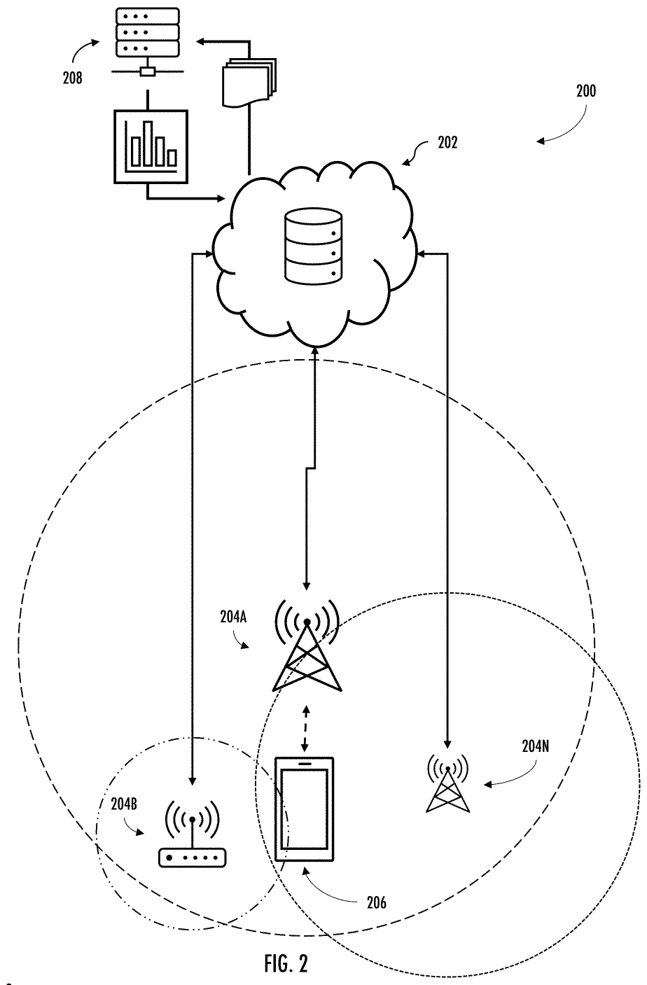

FIG. 2 is a logical block diagram of an exemplary heterogenous wireless network architecture 200 useful to explain various aspects of the present disclosure. As shown therein, the cellular network includes a network operator's compute resources 202 that manage a diverse set of communication protocols 204A, 204B . . . 204N to provide coverage to user equipment 206. Notably, the deployment of access nodes 204A, 204B . . . 204N is arbitrary and highly fluid. In some cases, access nodes may e.g., shut down when not in use, dynamically adjust coverage based on connectivity and/or bandwidth, etc.

In view of the complex requirements of 5G networks, so-called “Self-Organizing Network” (SON) technology is an important field of research that will enable mature 5G operation. In particular, it may not be feasible for a network operator to statically plan-for (or manage on a day-to-day basis) the variety of different equipment that is necessary to provide comprehensive 5G service. Consequently, 5G has introduced the concept of a “virtualized network”; in other words, 5G uses software-defined networks (SDNs) to provide the scalability and automation required for future 5G use cases.

Unlike traditional RAN operation which could be internalized within the network operator's compute resources, the virtualized network paradigm lets network operators dynamically adjust their networks for specific users and adapt networks based on traffic conditions. SON technology is generally divided into the following functionalities: self-configuration, self-optimization, self-healing, and self-protection. Specifically, self-configuration allows new network nodes to be deployed within existing deployments using automatic network discovery, calibration, and/or configuration. Self-optimization requires that each network node dynamically controls its own operational parameters to maximize its own performance. Self-healing ensures that the overall network handles individual node failures robustly. Self-protection prevents unauthorized access to the network.

Airhop Communications, Inc. has developed an enhanced SON (eSON) software that allows network operators to externalize real-time network optimizations to 3^{rd} party servers. For example, as shown in FIG. 2, a network operator can offload network statistics and data to an external server 208. The external server 208 can provide e.g., diagnosis, self-optimization and/or self-healing data and/or instructions back to the network operator's resources 202 for use.

Unfortunately, eSON software faces a variety of novel challenges. Notably, the external servers 208 do not have direct access or control to the physically deployed hardware. Unlike carefully planned traditional networks; eSON software must flexibly adapt to haphazard deployments and/or unknown interference conditions. The network operator's equipment may dynamically power-on, throttle up/down, and/or shut down without warning; in fact, the radio environment may also have other interference (e.g., other networks and/or radiation sources) that is entirely opaque to the network operator.

Additionally, network operators and/or equipment vendors often monitor (and mandate external service providers to monitor) proprietary metrics; in many cases, such proprietary metrics may have been inherited from legacy networks and may be subject to contractual/equipment constraints. Within heterogenous network deployments, the mishmash of proprietary metrics is often poorly (if at all) understood. In order to mitigate unknown risks, network operators may mandate that all such metrics are monitored, regardless of whether doing so would be redundant and/or computationally optimal.

In view of the foregoing, solutions for detecting anomalous network behavior are needed. Ideally, anomalous behavior should be detected based on actual data that is measured, rather than relying on domain expertise or other human insight to categorize anomalous/typical behavior. Furthermore, solutions should adapt to changes in data, without being over-sensitized or de-sensitized from previous data. More generally, improved solutions are needed for detecting anomalous behavior in systems with unknown and/or multivariate complexity.

### Example Operation

Various aspects of the present disclosure are directed to improved solutions for anomaly detection. In one exemplary implementation, an anomaly detection algorithm “automatically” generates a statistical model of its Key Performance Indicators (KPI) over batches of actual measured KPI without domain expert input. In one specific implementation, the anomaly detection algorithm calculates a covariance matrix to identify normal correlations between KPI; historic deviations from normal behavior can be used to generate alarms. Certain implementations may additionally pre-process KPIs into normalized input; the exemplary pre-processing flexibly accommodates raw numerical KPI input without regard to units (dimensionless input).

As described in greater detail hereinafter, fully automatic generation of statistical models (without domain expert input and/or human supervision) are likely to include degenerate data (e.g., linear combinations and/or null combinations). In order to avoid problems due to multicollinearity, various implementations may additionally incorporate data conditioning steps (e.g., Tikhonov regularization) so as to ensure that the statistical modeling remains well-conditioned.

In another aspect, an anomaly detection algorithm may “adaptively” monitor and adjust its statistical model to adjust for the addition, modification, and/or removal of Key Performance Indicators (KPI) between batched operation. In one exemplary implementation, the anomaly detection algorithm adaptively updates the statistical model of its KPIs so as to defensively handle missing data and/or invalid data (corrupted, malformed, impossible, etc.) In one specific instance, the statistical model removes anomalous data from its data set, this ensures that the statistical model is not de-sensitized (or overly sensitized) to the anomalous data.

Anomaly detection provides valuable information that can be used by humans to diagnose, plan, and/or monitor complex systems. Unfortunately, the myriad of different parameters (and near-infinite permutations) in modern systems have exceeded the cognitive abilities of humans. To these ends, various aspects of the present disclosure simplify anomaly labeling, so as enable a human domain expert to understand the nature of detected behavior in a digestible manner. Other improvements include e.g., temporal filtering, and magnitude of contribution (the most influential factors).

In one exemplary implementation, multiple novel aspects disclosed herein are combined into a so-called Automatic Adaptive Anomaly Detection (AAAD) algorithm that: uses any (and all) of the system KPI to identify significant and persistent anomalous events; assigns a label to detected anomalies; and allows for domain experts to decide if the anomalous events should be alarmable events.

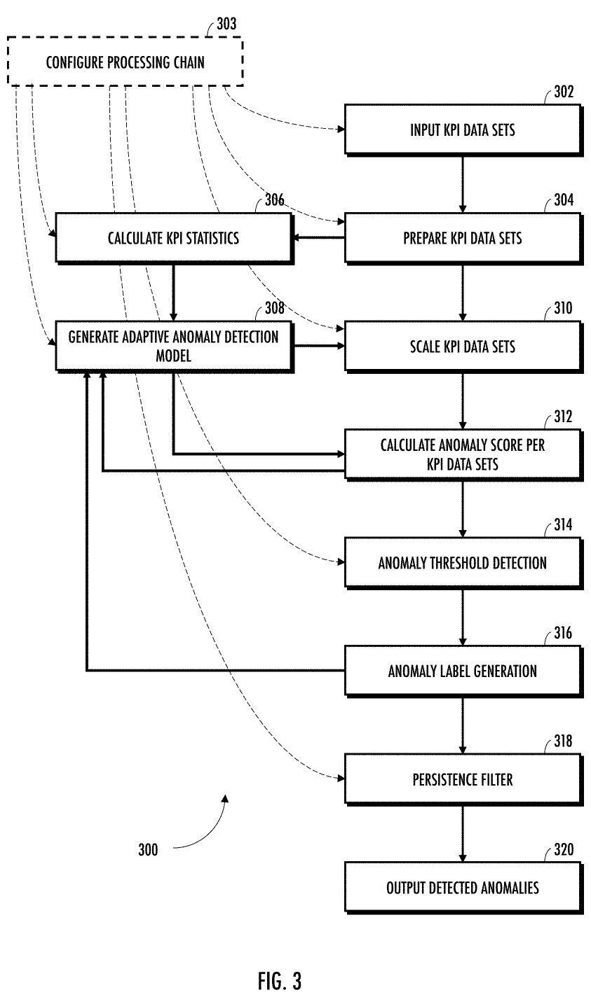

FIG. 3 is a logical flow diagram of an exemplary method 300 for automatic adaptive anomaly detection in accordance with various aspects of the present disclosure. In one exemplary embodiment, the method 300 is performed by a computing device such as e.g., the external server 208 of FIG. 2. During operation, the KPI processing path (steps 310-318) uses an anomaly detection model (from steps 306 and 308) to detect KPI data sets that are anomalous; detected anomalies are output/alarmed at step 320. In some variants, initial configuration parameters and pre-processing (steps 302-304) may improve true/false alarm accuracy and/or reduce anomaly detection latency.

Referring first to step 302, the computing device receives input Key Performance Indicators (KPI). As previously alluded to, the KPI may be the raw system data for a heterogenous network; thus, the KPI may include any number of variables and with any arbitrary units, in any numerosity or data structure.

In the following example, the term “Key Performance Indicator” or “KPI” may be used in reference to a scalar, a single metric, a data point, a data stream, a plurality of metrics, a data set arranged in a data structure (e.g., a vector or a matrix), etc. Artisans of ordinary skill in the related arts will readily appreciate that such references are for clarity, but that other data structures are contemplated and may be substituted with equal success, given the contents of the present disclosure. For example, KPI stored in other data structures may be converted or otherwise pre-formatted to an input KPI data series.

In some implementations, one or more processing chain parameters of the external server may be configured at step 303. Even though the exemplary processing chain parameters may automatically adapt over operation; initial configuration may reduce set-up time; similarly, ongoing configuration may enable gradual tweaks in the accuracy and/or presentation of anomaly detection. In one exemplary embodiment, the configuration parameters may allow a domain expert to set valid KPI ranges for identifying missing and/or invalid data, configure the threshold distance from typical behavior that is used to determine an anomaly, configure filters to detect small but persistent anomalies, and/or customize application relevant labels to replace the automatically generated alarm labels. In some cases, the configurable parameters may also include a batch size (a number of KPI data sets collected over time, location, etc.) that can be used to update the model.

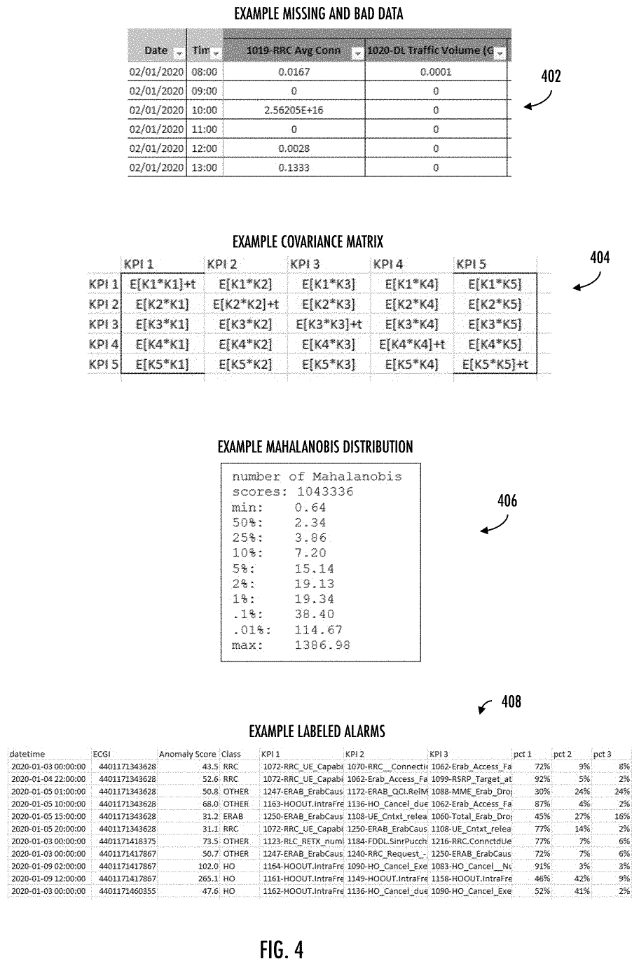

At step 304, the KPI data sets are prepared for anomaly detection. In one embodiment, the raw KPI data sets are pre-processed to remove missing and/or invalid data based on domain expert information (when available from step 303) and/or historic operation. Missing data can occur for many reasons and is a common problem in many systems. In one such implementation, missing data may be flagged with blank data, or a placeholder value (e.g., “-” or “n/a”.) Invalid data may be screened using a minimum and maximum allowable value setting for each KPI. FIG. 4 provides an example of invalid data 402. As shown therein, the value 2.56205E+16 for 1019-RRCAvgConn on date Feb. 1, 2020, at time 10:00, is physically impossible and could be excluded with a maximum allowed value; in this case, a domain expert may assign an allowed maximum value of e.g., 1000. Values that exceed the maximum allowed value can be replaced with the placeholder value “n/a”. After the missing/invalid data is conditioned, the raw KPI data sets may be scaled to normalized units for each KPI data point (or data stream) within the data set.

At step 306, Key Performance Indicator (KPI) statistics are calculated based on the prepared KPI data sets. At step 308, an adaptive anomaly detection model is generated and/or automatically updated based on the KPI statistics.

In one embodiment, a model of the normal and/or typical KPI values and a statistical relationship between the KPI is calculated using a covariance matrix, and an inverse covariance matrix. For example, the adaptive anomaly detection model may generate the following data structures: (i) a mean for each KPI data stream, (ii) a standard deviation for each KPI data stream, (iii) a covariance matrix derived from all KPI data streams in the data set, (iv) an inverse covariance matrix derived from the covariance matrix, and (v) an anomaly score threshold for the KPI data set.

In some implementations, the adaptive anomaly detection model may be initially trained with input KPI data sets that include a mix of normal and anomalous behavior. Such implementations may be desirable if most of the data is normal or typical when the algorithm starts. Alternatively, if most of the KPI data set is anomalous when the algorithm starts then the anomalous data may be mistakenly treated as typical data; in such cases, the adaptive anomaly detection model may need “settling” time during which subsequent normal/typical KPI data sets reduces the influence of the initial anomalous KPI data set from the model. When normal/typical data is available, the adaptive anomaly detection model may be pre-seeded to reduce settling time.

In some implementations, the adaptive anomaly detection model may be continually updated with new KPI statistics (from step 306), as the normal or typical behavior of the system may change over time. Additionally, the adaptive anomaly detection model may also be updated with feedback information from subsequent processing (see steps 312 and 316 described below). In some variants, the rate of update may be configured with each new batch of KPI data sets. In another related variant, the configuration parameters (if any were provided in step 303) may control how quickly or slowly the model should adapt. For example, if the network behavior of interest changes as a function of daily traffic, then the update rate should be on the order of a day. In contrast, if the network behavior of interest is seasonal, then the model time constants should be on the order of months.

As previously alluded to, the adaptive anomaly detection model may be automatically updated with new KPI data set (step 308). In some embodiments, the new KPI data points may be obtained piecemeal (e.g., one or a few at a time); other embodiments may batch new KPI data sets over windows of time or regions/areas of interest. For example, KPI may be buffered into 1-hour intervals, or according to a network service area. In some implementations, a batch of KPI may include one or more complete data sets of KPI.

In one embodiment, the adaptive anomaly detection model may be updated using time or batch filtered values. For example, a batch filtered implementation of a 1-pole infinite impulse response (IIR) filter operating on the KPI mean and standard deviations might be characterized according to the following equations:

New model KPI mean=α(Batch KPI mean)+β(Old model KPI mean) EQN. 1:

New model std=α(Batch KPI std)+β(Old model KPI std) EQN. 2:

$$α = ( \frac{1}{D} ) \qquad EQN . 3$$

$$β = ( \frac{( D - 1 )}{D} ) \qquad EQN . 4$$

Where D may be a configurable parameter configured at step 303.

In one embodiment, the KPI covariance matrix (Cov) is a K×K square matrix, where K is number of KPI metrics. The covariance matrix contains the covariance between each pair of KPI data points and its main diagonal contains the KPI variances for the KPI data set. Since multiple KPI data points are needed to calculate a covariance matrix, the KPI data points are grouped into a KPI data set before the covariance matrix is calculated. In some implementations, the covariance matrix can be updated with a 1-pole infinite impulse response (IIR) filter using a batched covariance matrix according to the following equations:

New model Cov=α(Batch Cov)+β(Old model Cov) EQN. 5:

Notably, one specific usage scenario for the exemplary anomaly detection scheme described herein, is where a nascent system has not yet matured to the point where the KPI data streams reflect a solid understanding of complex system dynamics. For example, KPI data streams for 5G networks may have been inherited from legacy homogenous networks and/or may be subject to longstanding contractual/equipment constraints. As a result, the covariance matrix described above may inaccurately overweight or underweight the importance of various KPI data streams. More directly, the arbitrary selection of input KPI for the covariance matrix is likely to be a degenerate matrix; e.g., the pairwise KPI data point relationships may exhibit multicollinearity. As a brief aside, multicollinearity occurs where one predictor variable in a multiple regression model can be linearly predicted from the other predictor variables with a substantial degree of accuracy. In this situation, the coefficient estimates of the multiple regression may change erratically in response to small changes in the model or the data. As a practical matter, if any of the KPI data points are all zeros, or if one KPI data point is a linear combination of the other KPI data points, then the covariance matrix exhibit multicollinearity.

Mathematically, a degenerate matrix cannot be inverted. Thus, in order to ensure that the covariance matrix is not degenerate, the covariance matrix is conditioned until it can be inverted to generate an inverse covariance matrix. A variety of different techniques for inverting and conditioning matrixes may be used.

As but one such example, Tikhonov regularization may be particularly useful to mitigate the problem of multicollinearity. Tikhonov regularization adds small positive value to the covariance matrix diagonals. FIG. 4 provides an example covariance matrix 404 that illustrates Tikhonov regularization for a 5×5 covariance matrix. The Tikhonov regularization constant (t) may be increased by a factor of 10 until the matrix is well conditioned. For example, if t=0.0001 is not sufficient, then t=0.001 is tried, and if that is not sufficient then t=0.01 is tried, etc. Since Tikhonov trades error bias for accuracy, an upper limit may be used to discard large deviations in behavior. For instance, Tikhonov regularization may be attempted until t=10⁶, at which point the entire batch of KPI data sets are discarded for model update purposes and the model is left unchanged.

Referring back to steps 306 and 308, an anomaly score threshold may be generated and/or updated based on feedback from subsequent processing. In one exemplary embodiment, the anomaly scores from step 312 (discussed below) may be input to the model to determine an anomaly score threshold. The anomaly score threshold is the value of recent scores that exceed a threshold percentage (e.g., the threshold percentage may be set at step 303). For example, a typical value for the threshold percentage may be 1%; e.g., KPI data streams that have anomaly scores that exceed 1% may be flagged as detected anomalies. Since multiple sets of KPI and corresponding anomaly scores may be needed to calculate the anomaly score threshold, the KPI data sets may be grouped into batches before calculating the anomaly score threshold. FIG. 4 depicts an exemplary Mahalanobis distribution 406 for a batch of 1043336 KPI data sets; the different anomaly score thresholds are grouped into percentiles (50%, 25%, etc.), additionally minimum and maximum anomaly scores may be provided. In this example, the anomaly threshold percentage of 1% corresponds to an anomaly score of 19.34.

In one embodiment, the anomaly score threshold may be updated using time or batch filtered values. For example, a batch filtered implementation of a 1-pole infinite impulse response (IIR) filter operating on the anomaly score threshold might be characterized according to the following equation:

New threshold=α(Batch threshold)+β(Old model threshold) EQN. 6:

Referring back to FIG. 3, once the anomaly detection model is generated/updated, the KPI processing path (steps 310-318) uses the anomaly detection model (discussed above) to detect KPI data sets that are anomalous.

At step 310, the KPI mean and standard deviations from previous iterations may be used to scale the new KPI data streams such that the output has roughly zero mean and unity variance. Scaling each KPI data stream in this manner removes any dependency on the units used for each KPI data point (feet, inches, meters, kilometers, etc.) In one such implementation, the KPI mean and standard deviations for each data stream are calculated and retained by the adaptive anomaly detection model over a number of iterations; the number of iterations may be specified by the configuration parameters (if any) established during step 303.

Next, at step 312, an anomaly score is calculated for each scaled KPI data set. The anomaly detection model's inverse covariance matrix is used to calculate an anomaly score for each KPI data set (KPI). In one exemplary embodiment, the anomaly score is the square of the Mahalanobis distance which is given by the equation:

Anomaly Score_{M}_{²}(KPI)=KPI^{T}·Cov⁻¹·KPI=[KPI^{T}·Cov⁻¹]·KPI EQN. 7:

More directly, a first dot product of the transposed KPI data set (KPI^{T}) and the inverse covariance matrix (Cov⁻¹) is calculated; then a second dot product is calculated between the first dot product and the KPI matrix (KPI). In the second dot product, the number of terms summed is the number of KPI. Mathematically, the dot product operator provides a magnitude of one or more vectors; thus, the anomaly score provides a magnitude of the anomalies for each KPI data set. Notably, the KPI data streams with the largest magnitude are taken to be the most influential KPI to its anomaly score (the magnitude of contribution may be used to label anomalies, described in step 316 below).

At step 314, the anomaly scores are compared to the anomaly score threshold (determined in steps 306 and 308 above) to identify KPI data sets that are anomalous. KPI data sets are anomalous if their anomaly score exceeds the anomaly score threshold.

At step 316, detected anomalies are labeled. In one exemplary embodiment, the automatic label may be string that is generated from the labels of the most influential KPI data streams. For example, consider the following simplified example of five anomaly scores:

$$Anomaly {Score}_{{M}^{2}} = [ \begin{matrix}Anomaly & {Score}_{{M}^{2}} ( K P {J}_{1} ) \\ Anomaly & {Score}_{{M}^{2}} ( KP {J}_{2} ) \\ Anomaly & {Score}_{{M}^{2}} ( K P {J}_{3} ) \\ Anomaly & {Score}_{{M}^{2}} ( K P {J}_{4} ) \\ Anomaly & {Score}_{{M}^{2}} ( K P {J}_{5} )\end{matrix} ] = [ \begin{matrix}10 \\ - 31 \\ 7 \\ 64 \\ 71\end{matrix} ]$$

The most influential KPI can be determined by sorting the KPI anomaly scores by magnitude. In this example, the ordered top-3 influential KPI are: Anomaly Score_{M}_{²}(KPI₅), Anomaly Score_{M}_{^{w}}(KPI₄), and Anomaly Score_{M}_{²}(KPI₂). A percent contribution can also be assigned using the following formula:

$${KPI\_PCT}_{x} = \frac{abs ( {KPI}_{x} )}{{\sum }_{N} abs ( {KPI}_{N} )} \qquad EQN 8$$

In this case:

$$Anomaly {Score}_{{M}^{2}} = [ \begin{matrix}{PCT\_KPI}_{5} \\ {PCT\_KPI}_{4} \\ {PCT\_KPI}_{2}\end{matrix} ] = [ \begin{matrix}\frac{71}{183} \\ \frac{64}{183} \\ \frac{31}{183}\end{matrix} ] = [ \begin{matrix}39 \% \\ 35 \% \\ 17 \%\end{matrix} ]$$

Other implementations may use e.g., a numeric identifier and/or tuple data structure, to enable ease of computer parsing. More broadly, since alarm labelling may be used for a variety of different applications (e.g., human review and/or automated machine parsing), alarm labeling may be configured in a variety of different ways. Common examples of such limitations may include e.g., saliency information (ranking), numerosity, label size, label frequency, and/or any number of parameters.

Referring back to FIG. 3, in some cases, persistence filtering may be used to identify persistent anomalous events (step 318). For example, certain types of anomalies should be ignored if they are short lived, but may trigger an alarm if they persist for some time. In one such implementation, the persistence filter is “K of L” filtering, i.e., the anomaly passes the persistence filter if, and only if, the anomaly is present in K of the last L KPI data sets. For example, if K=3 and L=5 then the anomaly passes the persistence filter if it is present in at least 3 of the last 5 KPI data sets. The persistence filter along with the anomaly threshold detection ensures that only significant and persistent anomalies are detected.

As shown in the labeled alarms 408 of FIG. 4, each set of KPI data streams corresponding to the same timestamp is shown in a “row” of the table. Rows with the same anomaly having anomaly scores above the anomaly score threshold over multiple timestamps may be considered persistently anomalous. In some cases, persistent anomalies may be treated similar to other anomalies; e.g., the most influential KPI (e.g., top 3) may be used to generate a persistent anomalous event alarm. In other cases, persistent anomalies may be treated differently to reflect the passage of time and/or the length of persistence.

In some cases, the persistent anomalous event alarm may require special handling during the automatic updating for the adaptive anomaly detection model. For example, certain persistent anomalies may de-sensitize (or over-sensitize) the adaptive anomaly detection model. In such cases, the anomalous rows of data (L) can be pruned with the placeholder value (e.g., “-” or “n/a”) in the training data set. Pruning out persistent anomalies ensures that the adaptive anomaly detection model is primarily influenced by the typical/normal data.

At step 320, the detected anomalies are output. In one exemplary embodiment, a computing device (such as e.g., the external server 208 of FIG. 2.) provides the detected anomalies to another device (such as e.g., a network operator 202 of FIG. 2). In other implementations, detected anomalies may be used to alert a user via a user interface (e.g., a haptic, audible, or visual alert of a smart phone). Still other implementations may incorporate the detected anomalies into local device operation (e.g., machine-based automation).

In one embodiment, the final outputs of the algorithm are labeled alarms that represent significant and persistent anomalies. The alarm data structure may include the anomaly score, automatic anomaly label, and the calculated percent contribution from the top KPI. The alarms may contain other data that is associated with the KPI but not used in the algorithm such as the date and time that the KPI were recorded.

In one embodiment, the alarms can be written to a file or communicated directly to the other application software entities. Some example labeled alarms 408 are shown in FIG. 4; the file includes e.g., an anomaly score, a top-3 KPI label, a top-3 calculated percent contribution, and other metadata (e.g., date and time, classification, etc.)

### Method

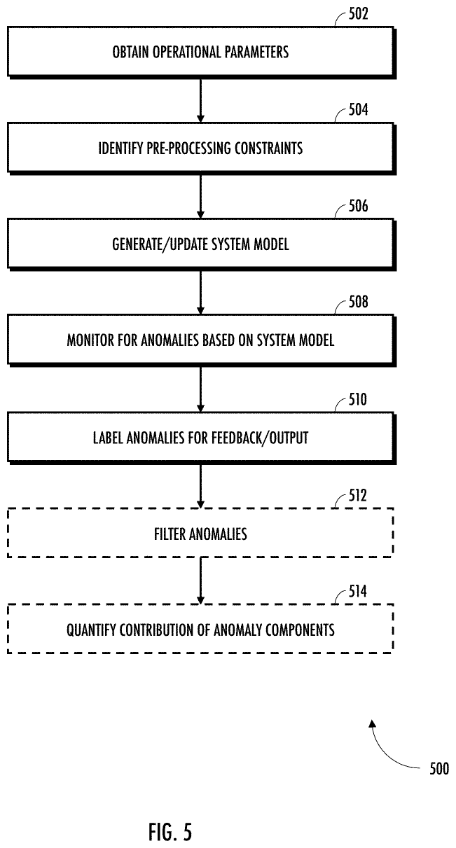

FIG. 5 is a logical flow diagram of a generalized method 500 for anomaly detection in accordance with various aspects of the present disclosure.

At step 502, operational parameters are obtained. In one exemplary embodiment, operational parameters are Key Performance Indicator (KPI) data obtained from a cellular network.

At step 504, pre-processing constraints are identified. In one exemplary embodiment, pre-processing constraints may include domain expert input to pre-configure valid data ranges, and/or configure desired reporting.

At step 506, a system model is generated and/or updated based on the operational parameters, pre-processing constraints, and/or system model feedback.

At step 508, the system model is used to monitor for anomalies.

At step 510, detected anomalies are labeled for feedback and/or subsequent output.

At step 512, the detected anomalies may be filtered based on a variety of considerations.

At step 514, the contribution of the anomalies' constituent components may be quantified.

### Apparatus

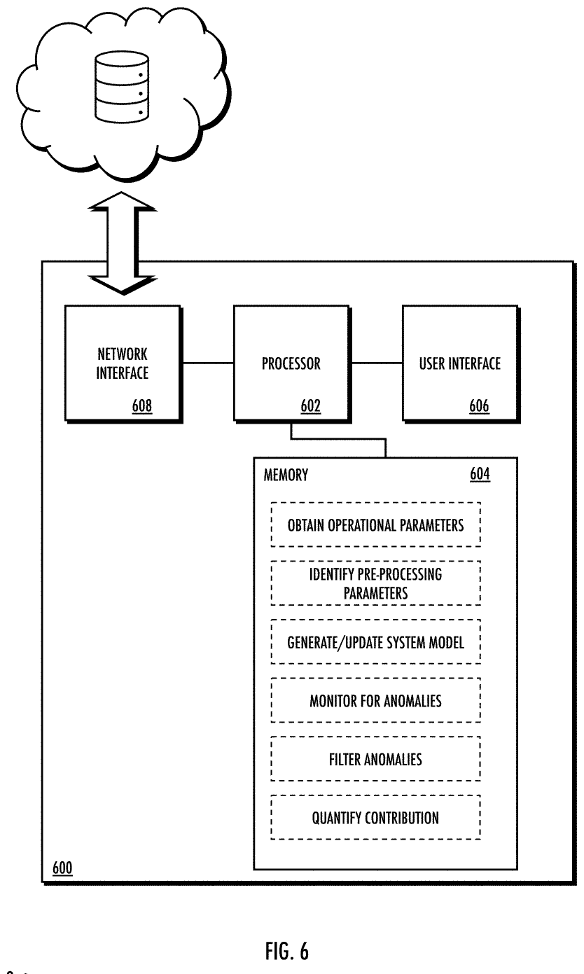

FIG. 6 is a logical block diagram of an apparatus 600 configured to detect anomalies in accordance with various aspects of the present disclosure. In one embodiment, the apparatus 600 includes a processor 602, non-transitory computer-readable medium 604, a user interface 606, and a network interface 608.

The components of the exemplary apparatus 600 are typically provided in a housing, cabinet or the like that is configured in a typical manner for a server or related computing device. It is appreciated that the embodiment of the apparatus 600 shown in FIG. 6 is only one exemplary embodiment of an apparatus 600 for the anomaly detection system; other data processing systems that are operative in the manner set forth herein may be substituted with equal success.

The processing circuitry/logic 602 of the server 600 is operative, configured, and/or adapted to operate the server 600 including the features, functionality, characteristics and/or the like as described herein. To this end, the processing circuit 602 is operably connected to all of the elements of the server 600 described below.

The processing circuitry/logic 602 of the server is typically controlled by the program instructions contained within the memory 604. The program instructions 604 include an anomaly detection application as explained in further detail above. The anomaly detection application at the server 600 is configured to communicate with and exchange data with other networked entities via its network interface 608. In addition to storing the instructions 604, the memory 604 may also store data for use by the anomaly detection application. As previously described, the data may include the Key Performance Indicator (KPI) and/or any data structures derived therefrom.

The network interfaces of the server 600 allows for communication with any of various devices using various means. In one particular embodiment, the network interface 608 is bifurcated into a first network interface for communicating with other server apparatuses and a second network interface for communicating with user devices. Other implementations may combine these functionalities into a single network interface, the foregoing being purely illustrative.

In one exemplary embodiment, the network interface 608 is a wide area network port that allows for communications with remote computers over the Internet (e.g., external databases). The network interface 608 may further include a local area network port that enables communication with any of various local computers housed in the same or nearby facility. In at least one embodiment, the local area network port is equipped with a Wi-Fi transceiver or other wireless communications device. Accordingly, it will be appreciated that communications with the server 600 may occur via wired communications or via the wireless communications. Communications may be accomplished using any of various known communications protocols.

In one exemplary embodiment, the network interface 608 is a network port that allows for communications with a population of user devices. The network interface 608 may be configured to interface to a variety of different networking technologies consistent with consumer electronics. For example, the network port may communicate with a Wi-Fi network, cellular network, and/or Bluetooth devices. In one exemplary embodiment, the server 600 is specifically configured to automatically and/or adaptively detect anomalies. In particular, the illustrated server apparatus 600 stores one or more computer-readable instructions that when executed e.g., obtain operational parameters, identify pre-processing parameters, generate and/or update a system model, monitor for anomalies, filter anomalies, and/or quantify the contribution of the anomalies constituent components.

### Technological Improvements and Other Considerations

The above-described system and method solves a technological problem in industry practice related to detecting anomalous behavior in unknown data environments. In one specific instance, modern wireless networks are not static and cannot be optimized prior to deployment; the fluid and dynamic nature of different technologies, different usage patterns, and complexity of radio frequency interactions can cause unknown behaviors. The various solutions described herein directly address a problem that was newly introduced by e.g., 5G wireless network deployments. Specifically, previous wireless networks could carefully plan-or or mitigate interference; 5G networks may require cooperation of between different computer data networks of massive scale, having widespread geographic distribution, and unknown radio frequency interactions.

As a related consideration, existing techniques for detecting anomalous behavior is often standardized between endpoints. For example, previous wireless networks (3G, 4G) could rely on standardized metrics across the radio access network. For example, base stations could rely on their user equipment to accurately report e.g., signal-to-noise-ratio in a timely and consistent (standardized) manner. The various solutions described herein enable anomaly detection across non-standardized system, such as those used in 5G cellular networks. In other words, the techniques described herein represent an improvement to the field of heterogenous computing environments.

Furthermore, the above-described system and method improves the functioning of the computer/device by robustly and reliably handling data of unknown correlation, quantity, and relevance. In one specific instance, virtualized networks experience wide variation in the type, format, and/or reporting of data. The above-described system and method specifically adapts to data that is invalid, missing and/or redundant or null, or otherwise multicollinear in nature. In one specific embodiment, the covariance, inverse covariance, and regularization ensures that the anomaly detection matrix is not degenerate (well-conditioned). In other words, instead of designing anomaly detection to accurately identify anomalies which may require an understanding of system operation, the solutions described herein provide less accurate anomaly detection but ensure that all input parameters are monitored. Such techniques are broadly applicable to any usage environment where domain expertise (or human cognition) is infeasible and/or unavailable.

### Various other Implementation Considerations

As used herein, the term “computer program” or “software” is meant to include any sequence of human or machine cognizable steps which perform a function. Such program may be rendered in virtually any programming language or environment including, for example, Python, JavaScript, Java, C#/C++, C, Go/Golang, R, Swift, PHP, Dart, Kotlin, MATLAB, Perl, Ruby, Rust, Scala, and the like.

As used herein, the terms “integrated circuit”, is meant to refer to an electronic circuit manufactured by the patterned diffusion of trace elements into the surface of a thin substrate of semiconductor material. By way of non-limiting example, integrated circuits may include field programmable gate arrays (e.g., FPGAs), a programmable logic device (PLD), reconfigurable computer fabrics (RCFs), systems on a chip (SoC), application-specific integrated circuits (ASICs), and/or other types of integrated circuits.

As used herein, the term “memory” includes any type of integrated circuit or other storage device adapted for storing digital data including, without limitation, ROM, PROM, EEPROM, DRAM, Mobile DRAM, SDRAM, DDR/2 SDRAM, EDO/FPMS, RLDRAM, SRAM, “flash” memory (e.g., NAND/NOR), memristor memory, and PSRAM.

As used herein, the term “processing unit” is meant generally to include digital processing devices. By way of non-limiting example, digital processing devices may include one or more of digital signal processors (DSPs), reduced instruction set computers (RISC), general-purpose (CISC) processors, microprocessors, gate arrays (e.g., field programmable gate arrays (FPGAs)), PLDs, reconfigurable computer fabrics (RCFs), array processors, secure microprocessors, application-specific integrated circuits (ASICs), and/or other digital processing devices. Such digital processors may be contained on a single unitary IC die or distributed across multiple components.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method for automatic adaptive anomaly detection, comprising:
obtaining sets of performance data from a cellular network;
calculating an adaptive anomaly detection model of the cellular network based on the sets of performance data; and
for at least a first set of performance data:
calculating a first anomaly score for the first set of performance data;
determining whether the first anomaly score exceeds an anomaly score threshold; and
labeling the first set of performance data when the first anomaly score exceeds the anomaly score threshold.

2. The method of claim 1, where the sets of performance data comprise numeric key performance indicators (KPI).

3. The method of claim 1, further comprising scaling the sets of performance data to have zero mean and unity variance.

4. The method of claim 1, where calculating the adaptive anomaly detection model of the cellular network comprises calculating one or more of a mean, a standard deviation, a covariance matrix, or an inverse covariance matrix.

5. The method of claim 1, where the sets of performance data from the cellular network are assigned a corresponding anomaly score that is based on a Mahalanobis distance.

6. The method of claim 1, where the anomaly score threshold is based on a history of anomaly scores.

7. The method of claim 1, where the anomaly score threshold is based on a percentile of Mahalanobis scores for the sets of performance data.

8. The method of claim 1, where labeling the first set of performance data includes generating a label based on a subset of performance data.

9. The method of claim 8, where the subset of performance data is determined based on a dot product of one or more vectors of the first set of performance data.

10. The method of claim 1, where calculating the first anomaly score is further based on a temporal filter that is configured to generate a positive output only if a first number (K) of a set of previous anomaly scores (L) are above the anomaly score threshold.

11. A server apparatus, comprising:
a network interface configured to obtain sets of performance data from a wireless network;
a processor; and
a non-transitory computer-readable medium that stores one or more computer-readable instructions that when executed by the processor, cause the server apparatus to:
calculate an adaptive anomaly detection model of the wireless network based on the sets of performance data; and
for at least a first set of performance data:
calculate a first anomaly score for the first set of performance data; and
determine whether the first anomaly score exceeds an anomaly score threshold.

12. The server apparatus of claim 11, where the adaptive anomaly detection model of the wireless network is based on a covariance matrix of the sets of performance data; and
where the one or more computer-readable instructions, when executed by the processor, further cause the server apparatus to:
mitigate multicollinear sets of operational parameters within the covariance matrix; and
generate a conditioned covariance matrix.

13. The server apparatus of claim 11, where the wireless network comprises a heterogenous wireless network characterized by a diverse set of communication protocols.

14. The server apparatus of claim 13, where the network interface is bifurcated into a first network interface configured to communicate with other server apparatuses and a second network interface configured to communicate with a set of user devices; and
where the set of user devices comprises at least a first user device of a first communication protocol and a second user device of a second communication protocol.

15. The server apparatus of claim 14, where the sets of performance data are obtained from the set of user devices via the second network interface.

16. The server apparatus of claim 14, where the sets of performance data are obtained from the other server apparatuses via the first network interface.

17. A server apparatus, comprising:
a processor;
a user interface configured to report labeled alarms; and
a non-transitory computer-readable medium that stores one or more computer-readable instructions that when executed by the processor, cause the server apparatus to:
obtain a set of operational parameters comprising at least one multicollinear relationship;
update an adaptive anomaly detection model based on the set of operational parameters;
detect at least one anomaly within the set of operational parameters based on the adaptive anomaly detection model; and
for each one of the at least one anomaly:
generate a labeled alarm based on an influential subset of the set of operational parameters; and
alert a user via the user interface with the labeled alarms.

18. The server apparatus of claim 17, where the user interface is further configured to report significant labeled alarms; and
the at least one anomaly comprises a significant anomaly that exceeds an anomaly threshold.

19. The server apparatus of claim 17, where the user interface is further configured to report persistent labeled alarms; and
the at least one anomaly comprises a persistent anomaly that persists for a first number (K) of a set of previous anomaly scores (L).

20. The server apparatus of claim 19, where the adaptive anomaly detection model is not updated with the persistent anomaly.
